(19) United States
(12) Patent Application Publication
(10) Pub. No.: US 2006/0092629 A1
(43) Pub. Date: May 4, 2006

(54) Flashlight

(76) Inventor: Hui-Lan Chen, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/979,321

(22) Filed: Nov. 3, 2004

(51) Int. Cl. F21L 4/00

(52) U.S. Cl. 362/157

(57) ABSTRACT

A flashlight formed of a bottom barrel, a top barrel, an inner socket, a driving socket, a lamp circuit assembly and a compression spring is disclosed and driven to switch on/off the LED of the lamp circuit assembly when the user moves the top barrel axially forwards/backwards relative to the bottom barrel.

### BACKGROUND OF THE INVENTION

(a) Field of the Invention

The present invention relates generally to a flashlight and more particularly, to such a flashlight, which can easily be switched on/off by moving the top barrel axially forwards/backwards relative to the bottom barrel.

(b) Description of the Prior Art:

A variety of flashlights are commercially available. These flashlights may have a different circuit design, however they commonly use a press button switch or rotary switch for on/off control.

### SUMMARY OF THE INVENTION

It is the main object of the present invention to provide a handy flashlight, which can easily be switched on/off by moving the top barrel axially forwards/backwards relative to the bottom barrel. It is another object of the present invention to provide a handy flashlight, which saves power consumption. According to one aspect of the present invention, the flashlight is comprised of a bottom barrel, a top barrel, an inner socket, a driving socket, a lamp circuit assembly, and a compression spring. The lamp circuit is so design that the LED of the lamp circuit assembly is switched on when the user moves the top barrel axially forwards from the bottom barrel, or switched off when the user moves the top barrel axially backwards to the bottom barrel. According to another aspect of the present invention, a resistor is installed in the lamp circuit assembly for use as conductor means in the circuit to save power consumption.

### BRIEF DESCRIPTION OF THE DRAWINGS

FIG. 1 is an elevational view of a flashlight according to the present invention.

FIG. 2 is a perspective view of the flashlight according to the present invention.

FIG. 3 is an exploded view of the lamp circuit assembly of the flashlight according to the present invention.

FIG. 4 is an exploded view of the flashlight according to the present invention.

FIG. 5 is a sectional view of the lamp circuit assembly according to the present invention, showing the LED switched off.

FIG. 6 is a sectional view of the lamp circuit assembly according to the present invention showing the LED switched on.

FIG. 7 is a sectional view of the present invention, showing the flashlight switched off.

FIG. 8 is a sectional view of the present invention, showing the flashlight switched on.

FIG. 9 is a sectional view of a part of the present invention, showing the extended status of the top barrel.

FIG. 10 is a sectional view of a part of the present invention, showing the received status of the top barrel.

FIG. 11 is an exploded view of an alternate form of the flashlight according to the present invention.

FIG. 12 is an assembly view of the flashlight shown in FIG. 11.

### DETAILED DESCRIPTION OF THE PREFERRED EMBODIMENTS

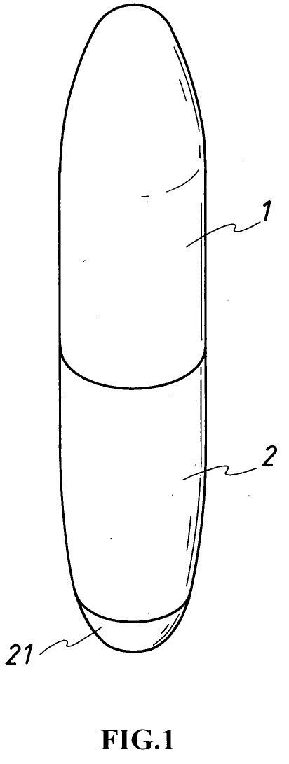

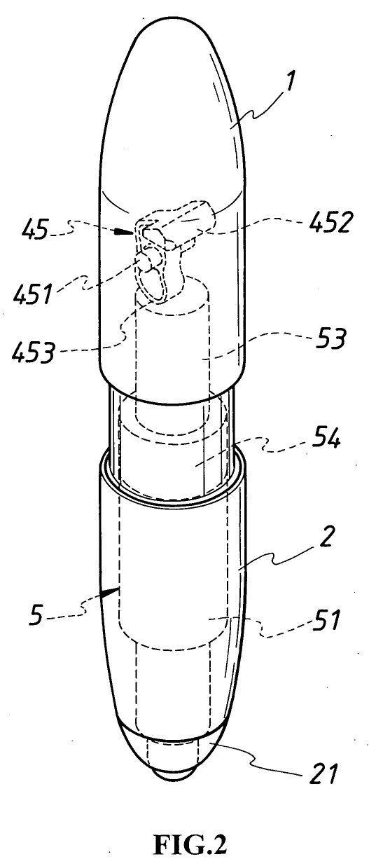

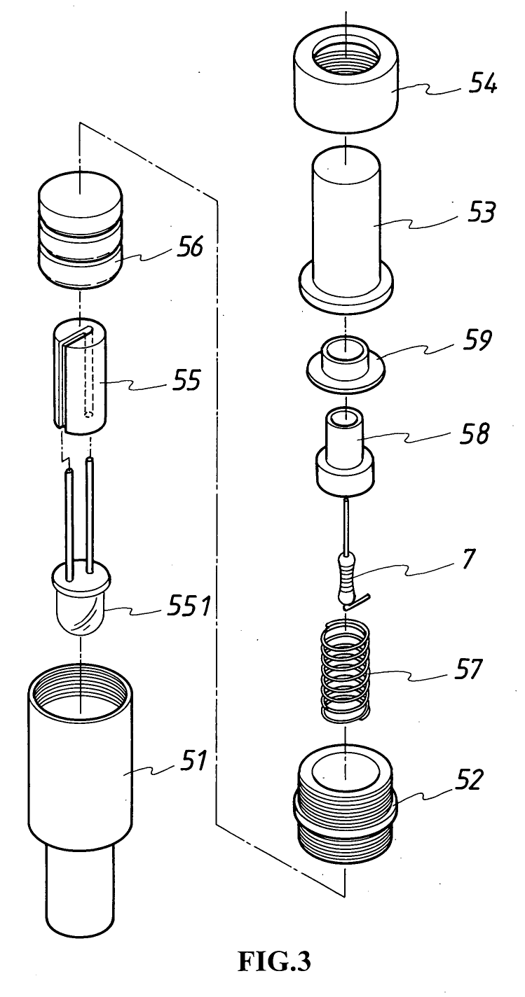

Referring to FIGS. 1˜3, a flashlight in accordance with the present invention is shown comprised of a top barrel 1, a bottom barrel 2, an inner socket 3, a driving socket 4, a lamp circuit assembly 5, and a compression spring 6.

The top barrel 1 is a hollow cylindrical cover member fitting over and capped on the inner socket 3.

The bottom barrel 2 is a hollow cylindrical cover member having a tapered annular bottom fitting 21 through which the LED 551 of the lamp circuit assembly 5 is moved out of the flashlight, and an inner thread 22 extended around the inside wall near the top end for receiving the driving socket 4.

The inner socket 3 comprises two longitudinal sliding slots 31 symmetrically disposed at two opposite sides near the bottom, an opening 32 spaced between the longitudinal sliding slots 31 near the top, a first stop rod 33 vertically suspended in the top side of the opening 32, and a second top rod 34 vertically suspended in the bottom side of the opening 32.

The driving socket 4 comprises an outer thread 41 extended around the periphery near the bottom end and threaded into the inner thread 22 of the bottom barrel 2, two pegs 42 symmetrically disposed at two opposite sides, a top slot 43 formed in the top end, an open chamber 44 disposed in communication with the top slot 43, an arched guide block 442 suspended in the open chamber 44 at the top near the top slot 43, a coupling groove 441 defined in the open chamber 44 at the bottom side of the arched guide block 442, and a push block 45 pivotally coupled to the coupling groove 441. The push block 45 is a curved member having a top working portion 452, a bottom working portion 453, and two pivot rods 451 symmetrically disposed at two opposite sides.

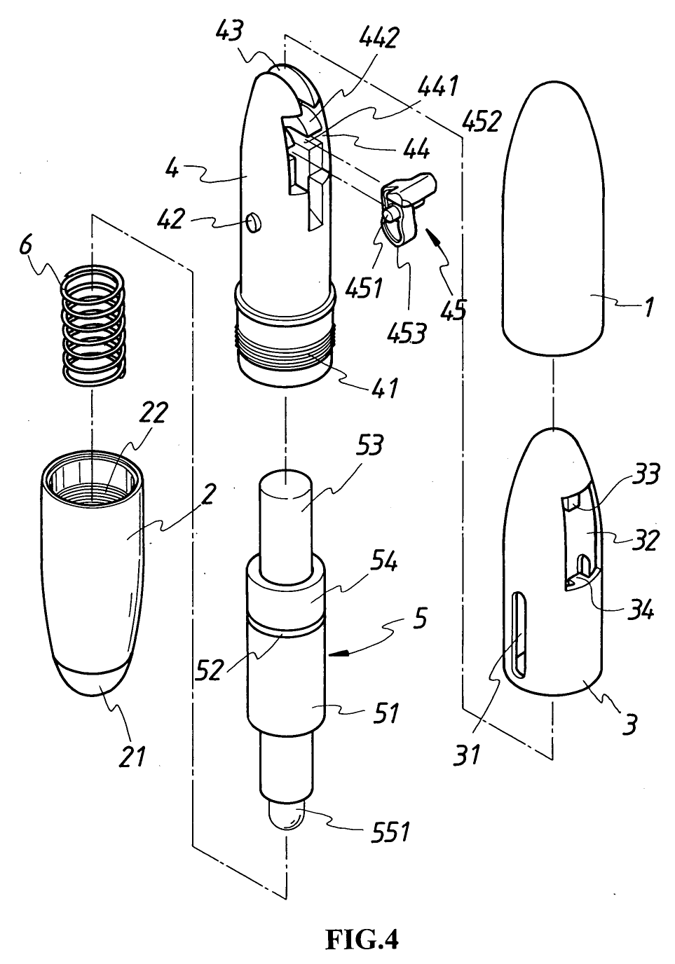

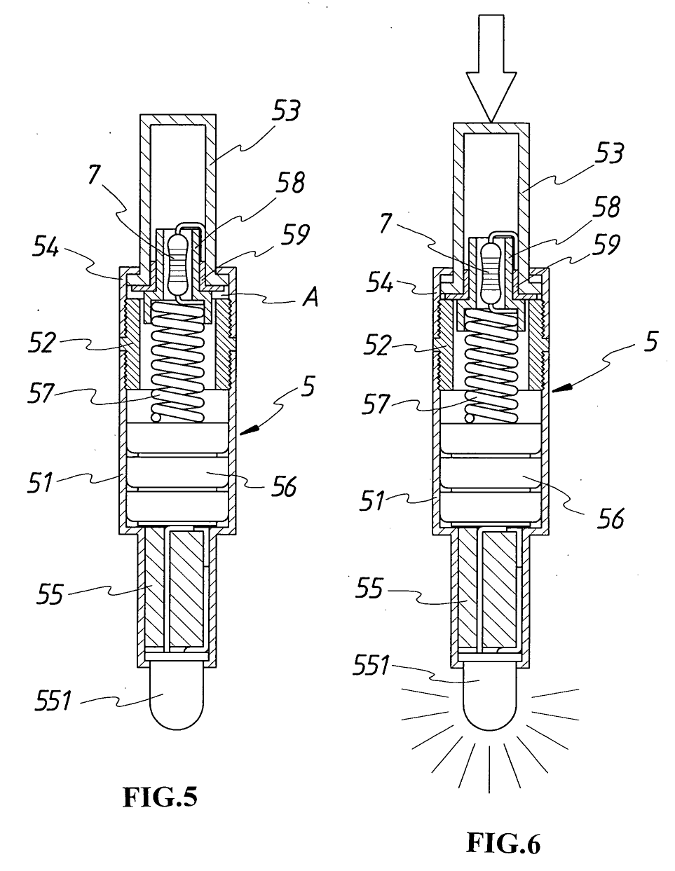

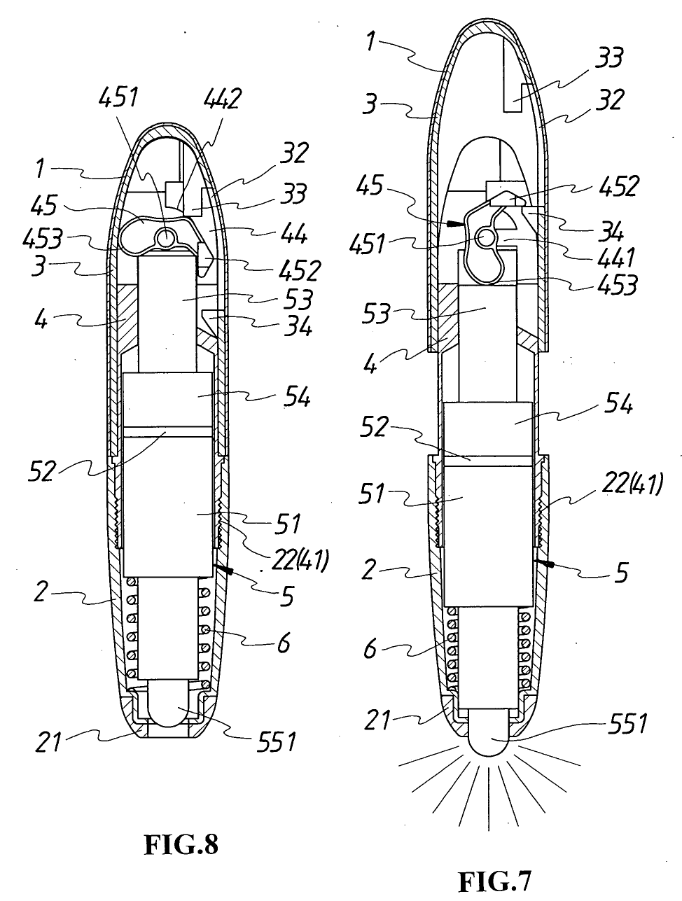

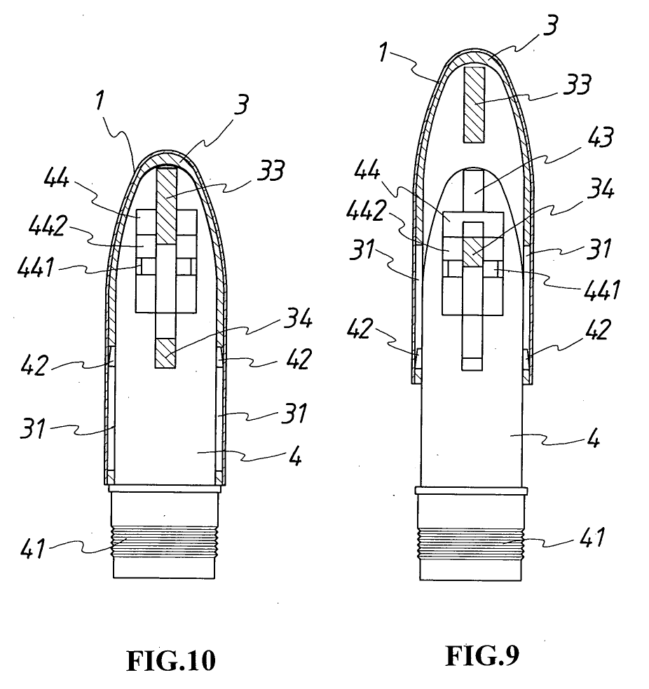

Referring to FIGS. 4˜6 and FIGS. 1˜3 again, the lamp circuit assembly 5 comprises a stepped hollow copper casing 51, a threaded metal connector 52 threaded into the top end of the copper casing 51, a hollow press button 53, a metal lock nut 54 threaded onto the threaded metal connector 52 to hold the press button 53, a LED holder block 55 mounted inside the casing 51, a LED 551 fastened to the LED holder block 55 and protruded over the bottom end of the copper casing 51, a plurality of battery cells 56 connected in series and mounted inside the copper casing 51 above the LED holder block 55, an insulative cap 58 mounted in between the threaded metal connector 52 and the hollow press button 53, a metal spring 57 supported between the battery cells 56 and the insulative cap 58, a metal cap 59 stopped between the insulative cap 58 and the hollow press button 53, and a resistor 7 mounted in the insulative cap 58. The resistor 7 has one end connected to the metal spring 57, and the other end extended out of the insulative cap 58 and connected to the inside wall of the metal cap 59 (see FIGS. 5 and 6). Normally, the metal spring 57 imparts an upward pressure to the insulative cap 58 and the metal cap 59 and the press button 53, thereby supporting the press button 53 in the extended position. At this time, a gap A is left between the metal cap 59 and the metal lock nut 54, and therefore the lamp circuit assembly 5 is off (see FIG. 5). However, when the user pressed the press button 53, the metal cap 59 is lowered to touch the metal connector 54, thereby closing the circuit, and therefore the LED 551 is on (see FIG. 6). Referring to FIGS. 7˜10, the driving socket 4 is inserted into the inner socket 3 inside the top barrel 1 with the two pegs 42 respectively coupled to the longitudinal sliding slots 31 of the inner socket 3. Therefore, the top barrel 1 and the inner socket 3 can be moved axially relative to the driving socket 4 within a distance corresponding to the length of the longitudinal sliding slots 31. During axial movement of the inner socket 3 relative to the driving socket 4, the first stop rod 33 and second stop rod 34 of the inner socket 3 will press or push the top working portion 452 or the bottom working portion 453. When the second stop rod 34 pushes the top working portion 452 of the push block 45, the bottom working portion 453 of the push block 45 will press the press button 53 of the lamp circuit assembly 5 to push the LED 551 out of the bottom barrel 2 and to switch on the LED 551. However, when the first stop rod 33 presses the bottom working portion 453, the press button 53 is released from the constraint and returned to its former position by the compression spring 6, and therefore the LED 551 is switched off and received inside the bottom barrel 2.

The push block 45 is moved along the arched guide block 442 by the first top rod 33 or second stop rod 34 to force the bottom working portion 453 against the press button 53 or to release the bottom working portion 453 from the press button 53.

According to the present invention, in addition to the function of working as a conductor to transmit electricity, the resistor 7 saves power consumption by means of the characteristic of its resistance. A metal conducting plate may be used to substitute for the resistor 7.

As the flashlight has a compact design, it is handy and convenient for carrying on the user's pocket.

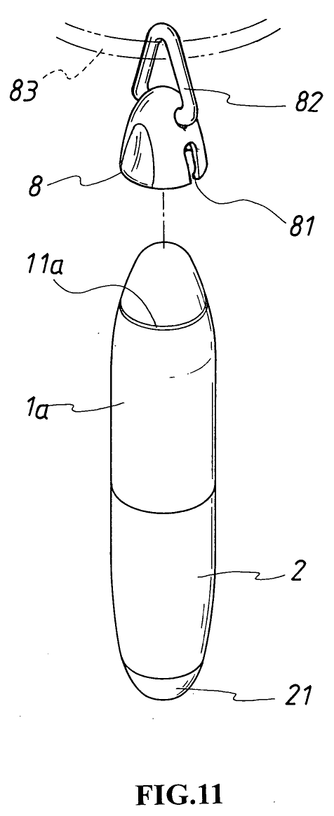

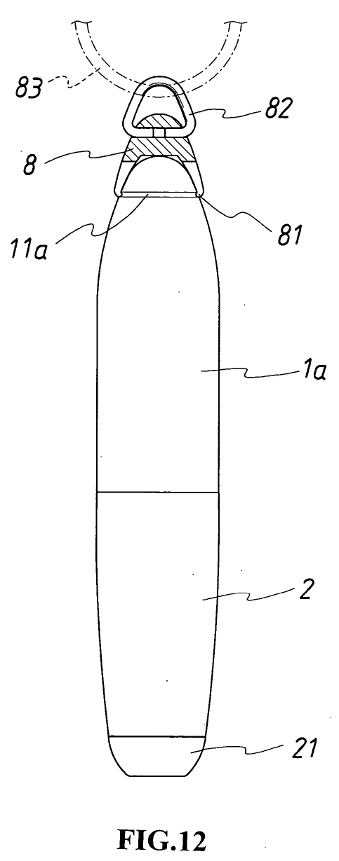

FIGS. 11 and 12 show an alternate form of the present invention. According to this embodiment, the top barrel, referenced by 1a, has a locating groove 11a extended around the periphery near the top end, and a hanging member 8 is fastened to the top barrel 1a for hanging. The hanging member 8 has a hooked portion hooked in the locating groove 11a, and a swivel ring 82 for hanging on a chain 83 or the like.

A prototype of flashlight has been constructed with the features of FIGS. 1˜12. The flashlight functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A flashlight comprising:
a top barrel;
a bottom barrel;
an inner socket fastened to the inside of said top barrel, said inner socket comprising two longitudinal sliding slots symmetrically disposed at two opposite sides, an opening spaced between said longitudinal sliding slots near a top side thereof, a first stop rod vertically suspended in said opening at a top side, and a second top rod vertically suspended in said opening at a bottom side;
a driving socket, said driving socket comprising a bottom end fastened to said bottom barrel, two pegs symmetrically disposed at two opposite sides and respectively coupled to said longitudinal sliding slots of said inner socket for guiding said inner socket to move with said top barrel relative to said driving socket, a top slot formed in a top end thereof, an open chamber disposed in communication with said top slot, an arched guide block suspended in said open chamber at a top near said top slot, a coupling groove defined in said open chamber at a bottom side of said arched guide block, and a push block pivotally coupled to said coupling groove;
a lamp circuit assembly, said lamp circuit assembly comprising a stepped hollow copper casing, a threaded metal connector threaded into a top end of said copper casing, a hollow press button, a metal lock nut threaded onto said threaded metal connector to hold said press button, a LED holder block mounted inside said copper casing, a LED (light emitting diode) fastened to said LED holder block and protruded over a bottom end of said copper casing, a plurality of battery cells connected in series and mounted inside said copper casing above said LED holder block, an insulative cap mounted in between said threaded metal connector and said hollow press button, a metal spring supported between said battery cells and said insulative cap, a metal cap stopped between said insulative cap and said hollow press button, and a conductor mounted in said insulative cap and connected between said metal spring and said metal cap;
wherein when moving said top barrel with said inner socket downwards relative to said driving socket, said first stop rod will be pressed on said push block to force said push block to press said press button and to further switch on said LED; when moving said top barrel with said inner socket upwards relative to said driving socket, said second stop rod will push said push block to force said push block away from said press said press button and to further switch off said LED.

2. The flashlight as claimed in claim 1, wherein said conductor is a resistor having a first end connected to said metal spring and a second end extended out of said insulative cap and connected to an inside wall of said metal cap.

3. The flashlight as claimed in claim 1, wherein said push block is an arched member having a top working portion corresponding to said first top rod of said inner socket, and a bottom working portion corresponding to said second stop rod of said inner socket.

4. The flashlight as claimed in claim 1, wherein said copper casing, said lock nut, and said metal cap are electrically conducting members.

5. The flashlight as claimed in claim 1, wherein said LED is movable in and out of a hollow bottom fitting of said bottom barrel.
